(19) United States
(12) Patent Application Publication
(10) Pub. No.: US 2011/0048308 A1
(43) Pub. Date: Mar. 3, 2011

(54) AUTONOMOUS DYNAMIC SAILING HULL

(76) Inventor: Stefan Tarkovacs, Osny (FR)

(21) Appl. No.: 12/865,653

(22) PCT Filed: Jan. 30, 2009
(86) PCT No.: PCT/IB09/00164

§ 371 Date: Nov. 15, 2010

(30) Foreign Application Priority Data
Feb. 1, 2008 (FR) 0800562

(51) Int. Cl. B63B 3/00; H01M 8/00; B63H 21/17

(52) U.S. Cl. 114/61.1; 114/65 R; 440/6

(57) ABSTRACT

This invention concerns a general principle for ship hulls known as “Autonomous Dynamic Sailing Hull”, built in whole or in part to contain, in the depth of its structure inside with compartments that are separated and sized for this purpose, in the space delimited by a double hull or within a portion of hull or adapted to the internal spaces of the ship, in a globally controlled system, one or two different types of gas and for some seawater compartments to be able to, on the one hand, produce by electrolysis, through one or more integrated fuel cell modules known as PEMFC, energy resources (electricity) required for the operation of propulsion and its equipment according to expected usage, on the other hand, modulating its mass and thus its navigation through ingestion or ejection of seawater.

This invention completes the patents registered with the INPI under the reference numbers: 0609784 (Publication No. 2 853 618) and from the European Patent Office under the reference number WO 2004/092006 PCT/FR2004/000900. The European publication number is 1648761, and under the reference number 0609784000.

The first patent mentioned, filed on Apr. 4, 2003, called “autonomous underwater station” lays claim to a hollow structure characterized in that it operates in its entirety as a complex system of ballasts designed to cancel, with the constant interplay of volumes of water taken in and drained, its own weight and that of its operational equipment in liquid environments.

It also lays claim to the technical implications for design options and loading of energy and operational autonomous means, direct implications of the hollow structure concept.
The second patent cited, filed on Nov. 9, 2006, referred to as “Dynamic Autonomous Underwater Structure” lays claim to the use of the internal volume of a structure such as fuel cell/storage and a system to compensate for external pressure exerted on that structure.

The usefulness of the principle called “Autonomous Dynamic Sailing Hull” of this invention derives directly from the previous patents referenced above in that it redefines the hull of any surface naval vessel, rather than underwater, sailing structure containing and producing its own energy source for propulsion, as well as its own means of buoyancy control.

The marine and fluvial ship hulls are designed to be able to support, on the surface of the water, masses equivalent to the mass of the water that they displace. Of inert design, these hulls are fitted with tanks added to take on fuel, and corresponding means of propulsion, such as an assembly comprised of one or more engines, one or more transmission shafts and one or more propellers.

Most of these hulls are not intended to compensate for major damage, and a tear is enough to put the mentioned hull in trouble.

The means of marine propulsion for the surface ships, while technically different and for some non-polluting, are overwhelmingly dependent on the burning of hydrocarbons.
Those operating on electrical energy require either large batteries, a complex system transforming combustion to electricity, or a photovoltaic installation or solar collectors.

In terms of pollution, it is rare that in the collectivity of these systems, a vessel, at one time or another, does not pollute the marine waters directly or indirectly.

The state of the technique already includes various concepts of marine propulsion concepts based on the use of fuel cells on board, powered either by a system of producing hydrogen/oxygen or hydrogen alone, as described in the patent GB 2 405 742 A of M Phillip Martin Usher, or even by the one from Mitsubishi Heavy Ind. Published under the No. 10167189, or by storage of these ready-to-use gases bottled under pressure associated with electric storage in batteries.

In terms of autonomy, the surface ships depend on the prominence given to fuel tanks and the power used. The processes cited above do not optimize the principle of the hull to increase a decisive autonomy, security, use of free space.

The device, according to the invention, is characterized in that it constitutes a new type of surface sailing hull aimed at addressing the issues listed above, namely:
no use of hydrocarbons
unsinkable hull by partitioned structure
lack of machinery
very long autonomy
economic and non-polluting fuel
self-fuel production by embedded system
silent engine, no vibration and no heat
variable hull balance/mass by lined ballast tanks, managed by computer

The device, according to the invention, is characterized in that the hull called “Autonomous Dynamic Sailing Hull” is constructed to be able to produce power without hydrocarbons or external sources such as solar energy, its own source of energy in the form of electricity by means of one or more fuel cell systems (PCs) included in the hull, powered by combustible gases (G), through hydrolysis, contained within the hull itself made up of two partitioned walls, giving the existing equipment a much greater autonomy.

The device, according to the invention, is characterized in that the hull called “Autonomous Dynamic Sailing Hull” is built to be able to significantly vary its center of gravity and general mass so as to more finely control the stress during navigation by one or more ballast systems (B) included in the structure and managed either by on-board computer or manually from a command and control station.

The device, according to the invention, called the “Autonomous Dynamic Sailing Hull”, characterized in that it is designed to produce, from the capacity of all the internal volumes of its structure and from the complementary existing technologies such as the fuel cell and the principle of electrolysis, adapted to the device and included, its own means of autonomy in terms of energy, buoyancy, control of the marine navigation.

The device, according to the invention, is characterized in that one or more watertight compartments in the structure incorporate the constitutive elements of one or more (PC) PEMFC fuels cells, i.e. anode, cathode, electrolyte membrane and any additional elements, fed directly by hydrogen and oxygen from other constitutive compartments of the structure containing these gases or only one of them (G) for the removal of ambient oxygen.

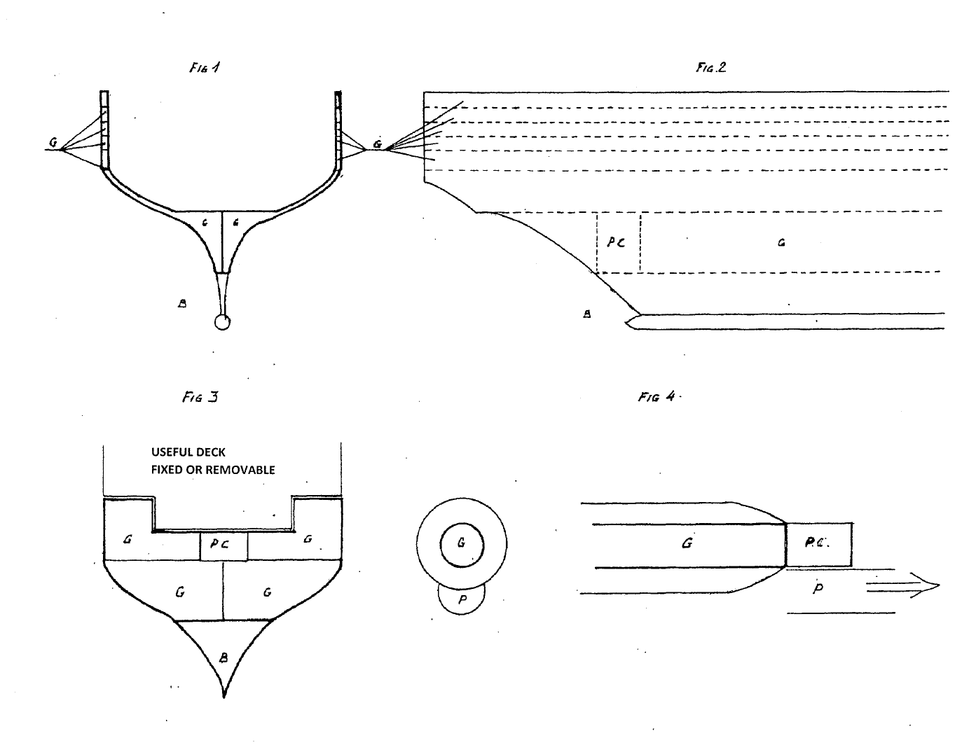

The device called “Autonomous Dynamic Hull” can be applied to all sizes and shapes of hull (FIGS. 1, 2, 3, 5, 6), semi-rigid (FIG. 4), mono and multihulls (FIGS. 7, 8), and all materials used to construct these hulls, associated or not associated with a lining of different material capable of containing these gases and according to existing technical standards.

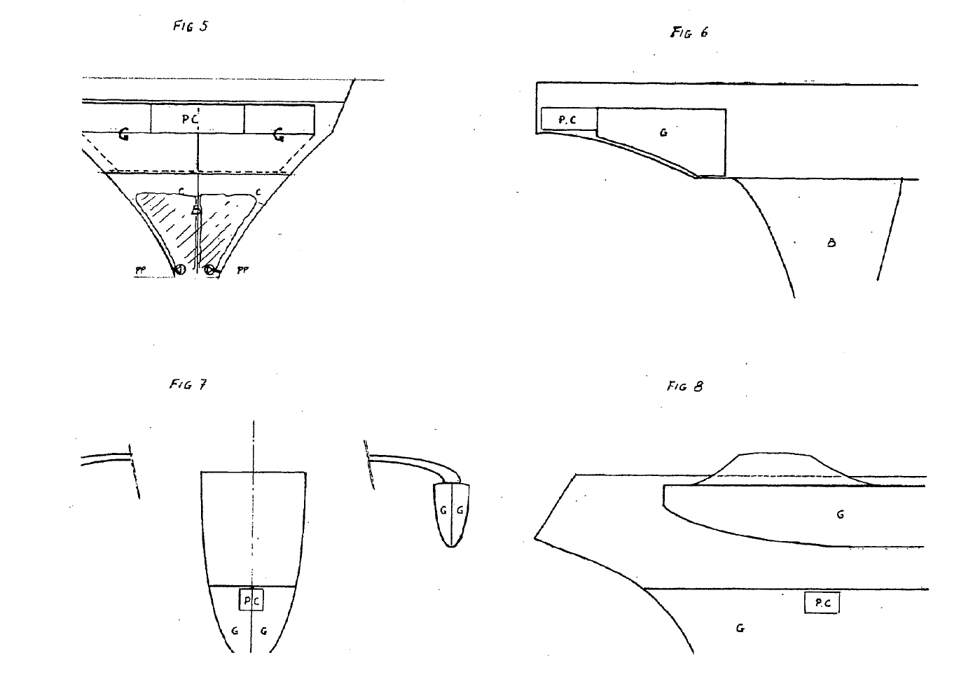

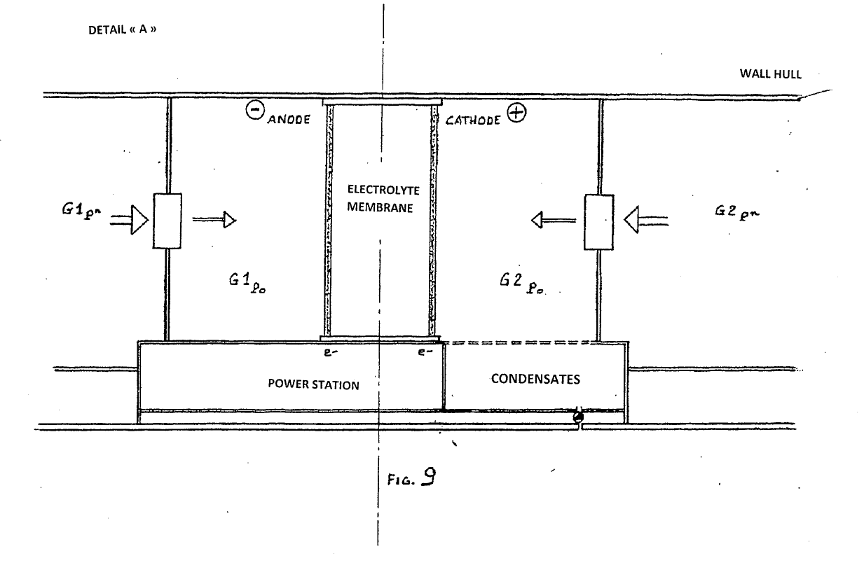

The device can be applied to an entire hull (FIGS. 1, 2) by its initial design of a double wall in whole or in part, or only partially (FIGS. 5, 6), i.e. by adding specific tanks, allowing both the modification and adaptation of the existing traditional ships as well as existing the classical know-how in shipbuilding.

The device, according to the invention, is characterized in that the sailing boat is made up of all or part of the ship in question, a double hull (FIG. 1), made of materials whose implementation makes it possible to keep separate in the compartmentalized spaces between the two hulls or parts of the hull, a part of the gases (G) under pressure and in the other part, in flexible lined tanks, the seawater (B), and in that all the compartments containing the gases are connected by automated valves and one or more fuel cell modules (PC), themselves included or not between the two hulls in compartments called “techniques”.

The layout and size of the container volumes included between the two hulls or installed in a single hull are a function of variable technical considerations, according to the capabilities sought such as:
resistance to damage: the proliferation of independent compartments ensures unsinkability in view of more or less major damage.
Autonomy: the container volumes determine the quantity of gas taken up and pressures tolerated, and thus, the importance of autonomy.
Security: any possibility of accidental puncture of the hull requires splitting the volumes based on the usage of the boat.
The balance of the ship: according to its design, its use and expected performance, all container compartments, water, heavy gas, light gas, will be arranged to enable adaptive management.

The conservation in marine environments of gas under pressure requires special attention to chemical and physical reaction. Thus, when making such a double steel hull, the inner surfaces of the two hull sides will be treated with an application of inert material, impermeable to the gas and appropriate for supporting the strongest ratio of expansion for the metal used (ex: spray-on plastic film, Teflon). In the case of manufacturing hulls in materials that are not resistant to internal pressures imposed by the principle, some compartment containers or tanks adapted to the interior of the hulls can be installed, according to the approved standards (FIGS. 5, 6).

In the case of the conversion of existing conventional ships, installation of tanks and modules for fuel cell technology can be adapted in place of conventional systems for energy generation and propulsion. An electric propulsion system or adapted Pods (P) may advantageously be suitable.

The device, according to the invention, is characterized in that, in some lower parts of the double-hull, some compartments act as ballast (B) whose characteristic is to be adjustable either by computer management based on the state of the sea, the intended speed or the load onboard, fixed or variable, or by manual operation, so as to optimize the balance and buoyancy of the ship according to the charge state of the fuel gases inside the hull. This load-adjustable ballast feature, included within the volumes of the double hull, is produced by the take-up or removal of seawater by the adapted pumps (PP) set in the outside of the compartments provided for this purpose. Seawater can be contained either directly in these compartments treated against corrosion, or in flexible containers (C) lining the compartments concerned. Pumps (PP) are tethered directly to the command and control station and to the management information system.

The compartments or reservoirs for ballasts are connected at the top to one or more automated outside air supply valves for the unlined ballasts, for admission of combustible gases contained in the adjoining compartments for lined ballast bladders.

The compartments or tanks containing pressurized gases are each interconnected by self-locking valves adapted to allow the distribution of internal pressures. All of these volumes are connected to one or more modules called the “fuel cell” integrated or not integrated in the hull. The system of safety valves is expected to close each of the compartments in the even of a sudden drop in the pressure of the gases for the said corresponding compartment, synonymous with damage. The entire “dynamic hull” thus uses its particularities for both manufacturing its energy and eliminating almost any risk of sinking. The whole hull serving, as a waterproof hollow body, as a buoy on the scale of the ship. The fluid circulation system from one compartment to another is designed to be used to reload by two standardized accesses to power without any possible error all the compartments, in two different gases or one only, if the installation uses external oxygen.

The gases in the major part of the compartments that make up the internal space of the double hull, or in the converted tanks in the case, for example, of an adaptation to conventional vessels, may be two different types, compatible with the electrolysis process for the fuel cell, such as oxygen and hydrogen, or only one type (hydrogen) if the installation and type of fuel cell are expected to remove the ambient oxygen.

In the case of two gases taken on simultaneously and can be very different densities, they will be from the design arranged so as to always maintain a perfect balance of the double-hull or tanks, regardless of the subdivision or the state of consumption for these gases.

The gases are stored under a pressure responding essentially to the standards allowed in the future, depending on the type of ship, the performance of the shipbuilding technique, the materials and finally, the intended autonomy.

The fuel cell (PC) modules producing electrical power from gas taken in on the structure of the hull or in added tanks as well as in the case of using ambient oxygen, are sized to suit the power for the electric motor selected (P), as well as the type of navigation provided in order to optimize the autonomy of it all.

The device, according to the invention, is characterized in that the fuel cell modules included in the structure leave all the useful part of the ship free. Inspection hatches for maintenance are fitted and guarantee the access and waterproofing by all appropriate means. In this case, unlike the adaptation of the system on conventional ships, the fuel cell modules are sized and positioned so as to integrate without intermediary installations in contact with the combustibles previously decompressed in the “decompression” compartments located on either side of the fuel cell module (Plate 3).

Some types of ships are, for various technical reasons, limited in their internal and external dimensions. To suit these constraints, as well as to provide for the amendment of existing vessels, this invention relates to any installation of a tank assembly for pressurized gas connected to a fuel cell system for surface ships, and with the goal of electrical energy production.

The different types of fuel cell installations in surface sailing anticipated by this invention are manifold:
Installation of a “fuel cell/tank”r module independent of the hull installed in the interior of the conventional sailing ship or prototype (FIGS. 5, 6).
Installation of a “fuel cell/tank” module that may or may not be included in the structure of sailing ships called “semi rigid” (FIG. 4)
Installation of a “fuel cell/tank” module included in the hull for any or part of the sailing ship (FIGS. 1, 2, 3, 7, 8).

The principle, according to the invention is characterized in that the electrical energy supplied by the “autonomous dynamic sailing hull” as a fuel cell, is proportional to the size of the ship and does not require any additional energy source. It is equipped according to the needs of all types of batteries found suitable for operating the type of associated fuel cell and for energy storage.

The basic equipment becomes the function of the type of use intended for the ship placed in the water. This equipment includes, apart from the batteries, various electric marine propellers, various compressors, pumps and valves, as well as a central computer, and all control materials and those controlling the complex system for exchange of the volumes taken in for gas and water. They include systems for safe navigation, and all equipment useful for maritime or fluvial sailing.

### ILLUSTRATIONS

Plate 1: FIGS. 1 and 2 double hulls for large ships,
:FIG. 3 hull-tank for pleasure ships, fishing, etc.
:FIG. 4 system integrated into the structures of the semi-rigid

Plate 2: FIGS. 5 and 6 system developed inside a hull in whole or in part
:FIGS. 7 and 8 system adapted to multihulls

Plate 3: diagram of the “fuel cell” assembly integrated into the structure of a ship or independent.

1. Autonomous dynamic sailing hull integrated or added into its structures the technologies called fuel cells, such as the state of the technology cited in “Journal of Power Sources”, entitled “Fuel cells going on board” (XP004194100), double hulls, lined ballast with flexible, internal tanks and any means of internal IT support, characterized in that it is designed to be able to produce, at the scale of its construction, its own energy resources in electrical shape with complete autonomy, and that includes
a double hull (FIGS. 1, 2, 3) for all or part of the ship forming compartments on the one hand that are “technical” containing one or more complete accessible “fuel cell” (PC) installation and, on the other hand, some interconnected compartments, containers or tanks and fuel cell modules by assisted valves or flaps and whose volumes contain all relevant gases (G) of a different nature, separated and pressurized in large quantities and used as fuel by hydrolysis, such as hydrogen “H²” (G) and oxygen “O” (G) if necessary
one or more modules called “PEMFC fuel cell” (PC) (Plate 3) or equivalent electric power generators, by anode, cathode and electrolyte membrane, inserted into the compartments of the double hull or even arranged within it, calculated depending on the energy needs of the vessel and supplied with fuel gases (G) by the container volumes or compartments of the mentioned hull
a ballast system contained in certain compartments of the hull, lined with flexible internal bladders intended to contain water, directly connected to the exterior by double flow pump and has the functions to control the navigation control system, to better control the center of gravity and the seaworthiness of the entire so-called hull for taking on or discharging water
a comprehensive computerized and manual management system for all elements known as “dynamic” such as gas tanks, sea water tanks, fuel cell modules, propulsion, pumps, batteries and other instruments

2. Dynamic sailing hull, according to claim 1, characterized in that the energy system taken on under the form of modules known as “fuel cell” PEMFC (PC), i.e. anode, cathode, electrolyte membrane and all additional items necessary included in the double hull; in that no system for fuel storage in any form is needed, the double hull or converted hull fulfill this function themselves and on the different types of fuel cell installations in surface sailing according to the invention in which:
the installation of a “fuel cell/tank” module independent of the hull installed within a conventional sailing ship or prototype (FIGS. 5, 6)
Installation of a “fuel cell/tank” module that may or may not be included in the structure of sailing ships called “semi rigid” (FIG. 4)
Installation of a “fuel cell/tank” module included in the hull for any or part of the sailing ship (FIGS. 1, 2, 3, 7, 8).

3. Dynamic sailing hull, according to claim 1, characterized in that the basic design adapts to any shape and scale such as mono-hull, multihull or semi-rigid, while retaining the same characteristics, some hull elements cannot be lined such as the bodies related to the multihulls.

4. Dynamic sailing hull, according to claim 1, characterized in that its principle can be adapted to be installed within a conventional hull, by adding pressurized tanks of the fuel gases and one or more modules known as “fuel cell” and a compatible engine and based on admissible present and future technical standards.

5. Dynamic sailing hull, according to claim 2, characterized in that the basic design adapts to any shape and scale such as mono-hull, multihull or semi-rigid, while retaining the same characteristics, some hull elements cannot be lined such as the bodies related to the multihulls.

6. Dynamic sailing hull, according to claim 2, characterized in that its principle can be adapted to be installed within a conventional hull, by adding pressurized tanks of the fuel gases and one or more modules known as “fuel cell” and a compatible engine and based on admissible present and future technical standards.

7. Dynamic sailing hull, according to claim 3, characterized in that its principle can be adapted to be installed within a conventional hull, by adding pressurized tanks of the fuel gases and one or more modules known as “fuel cell” and a compatible engine and based on admissible present and future technical standards.
